(19) United States
(12) Patent Application Publication
(10) Pub. No.: US 2026/0303682 A1
(43) Pub. Date: Oct. 1, 2026

(54) Server Placement in Interconnected System Environments using Digital Twins

(71) Applicant: International Business Machines Corporation, Armonk, NY (US)

(72) Inventors: Jing Lu, Beijing (CN); Dong Hui Liu, Beijing (CN); Peng Hui Jiang, Beijing (CN); Jia Tian Zhong, Hong Kong (HK); Jia Yu, Beijing (CN)

(21) Appl. No.: 19/096,961

(22) Filed: Apr. 1, 2025

(51) Int. Cl. H04L 67/1008; G06F 1/20; G06F 11/30

(52) U.S. Cl. CPC H04L 67/1008; G06F 1/20; G06F 11/3058

(57) ABSTRACT

Server placement is provided. An amount of workload traffic is detected between each candidate area unit in a list of candidate area units of a plurality of area units comprising an interconnected system environment in a digital twin and each of a set of destination server segments having a probability density value for server workload access less than a defined probability density threshold value for server workload access. Candidate area units are removed from the list of candidate area units having an amount of workload traffic to the set of destination server segments greater than a workload traffic threshold. A set of recommended candidate area units to place a server within the interconnected system environment is generated based on removing those candidate area units from the list of candidate area units having the amount of workload traffic to the set of destination server segments greater than the workload traffic threshold.

### BACKGROUND

The disclosure relates generally to interconnected systems and more specifically to managing interconnected systems.

An interconnected system refers to a network of computing devices, such as computers, servers, mainframes, or other data processing devices, that are connected together, where the operation of one computing device can impact the others. An example of an interconnected system is a datacenter. An interconnection system involves linking these computing devices, both hardware and software, to allow them to work together and share information. These interconnected systems link computing devices via high-speed networks, ensuring rapid data exchange and redundancy while allowing for load balancing, fault tolerance, and efficient resource allocation.

These interconnected systems enhance functionality, enable better data integration, and improve overall efficiency. These interconnected systems also provide for scalability, allowing these interconnected systems to handle growing amounts of workload and accommodate future growth, which is needed by entities, such as businesses and organizations, to ensure adaptability and expansion in response to evolving needs and technological advancements.

### SUMMARY

According to one illustrative embodiment, a computer-implemented method is provided. The computer-implemented method detects an amount of network workload traffic between each candidate area unit in a list of candidate area units of a plurality of area units comprising an interconnected system environment in a digital twin and each of a set of destination server segments having a probability density value for server workload access less than a defined maximum probability density threshold value for server workload access. The computer-implemented method removes those candidate area units from the list of candidate area units having a detected amount of network workload traffic to the set of destination server segments greater than a defined maximum network workload traffic threshold level. The computer-implemented method generates a set of recommended candidate area units to place a server within the interconnected system environment based on removing those candidate area units from the list of candidate area units having the detected amount of network workload traffic to the set of destination server segments greater than the defined maximum network workload traffic threshold level. According to other illustrative embodiments, a computer system and computer program product are provided.

### BRIEF DESCRIPTION OF THE DRAWINGS

FIG. 1 is a pictorial representation of a computing environment in which illustrative embodiments may be implemented;

FIG. 2 is a diagram illustrating an example of a server placement management system in accordance with an illustrative embodiment;

FIG. 3 is a diagram illustrating an example of a kernel density estimation for server workloads graph in accordance with an illustrative embodiment; and

FIGS. 4A-4C are a flowchart illustrating a process for positioning servers in interconnected systems using digital twins in accordance with an illustrative embodiment.

### DETAILED DESCRIPTION

A computer-implemented method detects an amount of network workload traffic between each candidate area unit in a list of candidate area units of a plurality of area units comprising an interconnected system environment in a digital twin and each of a set of destination server segments having a probability density value for server workload access less than a defined maximum probability density threshold value for server workload access. The computer-implemented method removes those candidate area units from the list of candidate area units having a detected amount of network workload traffic to the set of destination server segments greater than a defined maximum network workload traffic threshold level. The computer-implemented method generates a set of recommended candidate area units to place a server within the interconnected system environment based on removing those candidate area units from the list of candidate area units having the detected amount of network workload traffic to the set of destination server segments greater than the defined maximum network workload traffic threshold level. As a result, illustrative embodiments provide a technical effect of determining an appropriate area unit of a plurality of area units within an interconnected system environment to place a server to optimize temperature, power consumption, and workload response time based on amount of network workload.

The computer-implemented method ranks the set of recommended candidate area units from least amount of detected network workload traffic to the set of destination server segments to greatest amount of detected network workload traffic to the set of destination server segments to form a ranked set of recommended candidate area units to place the server within the interconnected system environment. The computer-implemented method outputs the ranked set of recommended candidate area units to place the server within the interconnected system environment to a client device of a user. As a result, illustrative embodiments provide a technical effect of ranking recommended candidate area units from least amount of detected network workload traffic to a set of destination server segments to greatest amount of detected network workload traffic to the set of destination server segments for recommending candidate area units to a user to place a server within an interconnected system environment.

The computer-implemented method identifies an amount of refrigeration area coverage provided by each respective refrigeration unit of a refrigeration system that controls temperature of the interconnected system environment. The computer-implemented method divides the interconnected system environment into the plurality of area units in the digital twin based on the amount of refrigeration area coverage provided by each respective refrigeration unit of the refrigeration system. As a result, illustrative embodiments provide a technical effect of dividing an interconnected system environment into a plurality of area units in a digital twin based on amount of refrigeration area coverage provided by each respective refrigeration unit of a refrigeration system that controls temperature of the interconnected system environment.

The computer-implemented method collects ambient temperature and power consumption data corresponding to each respective server of a plurality of servers running workloads in each respective area unit of the plurality of area units comprising the interconnected system environment in the digital twin. The computer-implemented method generates the list of candidate area units of the plurality of area units comprising the interconnected system environment for placement of the server within the interconnected system environment based on the ambient temperature and power consumption data of each respective server of the plurality of servers running workloads in each respective area unit of the plurality of area units comprising the interconnected system environment in the digital twin. As a result, illustrative embodiments provide a technical effect of generating a list of candidate area units of a plurality of area units comprising an interconnected system environment for placement of a server within the interconnected system environment based on ambient temperature and power consumption data of each respective server of a plurality of servers running workloads in each respective area unit of the plurality of area units comprising the interconnected system environment in a digital twin.

The computer-implemented method retrieves historical network communication information corresponding to workloads running on a plurality of servers within the interconnected system environment. The computer-implemented method performs an analysis of the historical network communication information corresponding to the workloads running on the plurality of servers within the interconnected system environment. The computer-implemented method determines a probability of a set of server segments corresponding to certain server destination Internet Protocol (IP) addresses of the plurality of servers running the workloads within the interconnected system environment based on the analysis of the historical network communication information corresponding to the workloads running on the plurality of servers within the interconnected system environment. As a result, illustrative embodiments provide a technical effect of determining a probability of a set of server segments corresponding to certain server destination IP addresses of a plurality of servers running workloads within an interconnected system environment based on analysis of historical network communication information corresponding to the workloads running on the plurality of servers within the interconnected system environment.

The computer-implemented method, using a kernel density estimation algorithm, inferences the probability density value for server workload access associated with each respective server segment of a set of server segments corresponding to certain server destination IP addresses of a plurality of servers running the workloads within the interconnected system environment. The computer-implemented method identifies one or more intensive workload access destination server segments in the set of server segments corresponding to the certain server destination IP addresses of the plurality of servers running the workloads within the interconnected system environment having the probability density value for server workload access greater than the defined maximum probability density threshold value for server workload access. The computer-implemented method removes the one or more intensive workload access destination server segments having the probability density value for server workload access greater than the defined maximum probability density threshold value for server workload access from the set of server segments corresponding to the certain server destination IP addresses of the plurality of servers running the workloads within the interconnected system environment to form the set of destination server segments having the probability density value for server workload access less than the defined maximum probability density threshold value for server workload access. As a result, illustrative embodiments provide a technical effect of determining a set of destination server segments having a probability density value for server workload access less than a defined maximum probability density threshold value for server workload access by removing intensive workload access destination server segments having the probability density value for server workload access greater than the defined maximum probability density threshold value for server workload access from server segments corresponding to certain server destination IP addresses of a plurality of servers running workloads within an interconnected system environment.

The computer-implemented method receives a request to add the server to a plurality of servers running workloads in the interconnected system environment from a client device of a user. The computer-implemented method, using a digital twin generation component, generates the digital twin of the interconnected system environment in response to receiving the request to add the server to the plurality of servers running workloads in the interconnected system environment. As a result, illustrative embodiments provide a technical effect of generating a digital twin of an interconnected system environment in response to receiving a request to add a server to a plurality of servers running workloads in an interconnected system environment.

A computer system comprises a processor set, one or more computer-readable storage media, and program instructions stored on the one or more computer-readable storage media to cause the processor set to perform operations. The computer system detects an amount of network workload traffic between each candidate area unit in a list of candidate area units of a plurality of area units comprising an interconnected system environment in a digital twin and each of a set of destination server segments having a probability density value for server workload access less than a defined maximum probability density threshold value for server workload access. The computer system removes those candidate area units from the list of candidate area units having a detected amount of network workload traffic to the set of destination server segments greater than a defined maximum network workload traffic threshold level. The computer system generates a set of recommended candidate area units to place a server within the interconnected system environment based on removing those candidate area units from the list of candidate area units having the detected amount of network workload traffic to the set of destination server segments greater than the defined maximum network workload traffic threshold level. As a result, illustrative embodiments provide a technical effect of determining an appropriate area unit of a plurality of area units within an interconnected system environment to place a server to optimize temperature, power consumption, and workload response time based on amount of network workload.

The computer system ranks the set of recommended candidate area units from least amount of detected network workload traffic to the set of destination server segments to greatest amount of detected network workload traffic to the set of destination server segments to form a ranked set of recommended candidate area units to place the server within the interconnected system environment. The computer system outputs the ranked set of recommended candidate area units to place the server within the interconnected system environment to a client device of a user. As a result, illustrative embodiments provide a technical effect of ranking recommended candidate area units from least amount of detected network workload traffic to a set of destination server segments to greatest amount of detected network workload traffic to the set of destination server segments for recommending candidate area units to a user to place a server within an interconnected system environment.

The computer system identifies an amount of refrigeration area coverage provided by each respective refrigeration unit of a refrigeration system that controls temperature of the interconnected system environment. The computer system divides the interconnected system environment into the plurality of area units in the digital twin based on the amount of refrigeration area coverage provided by each respective refrigeration unit of the refrigeration system. As a result, illustrative embodiments provide a technical effect of dividing an interconnected system environment into a plurality of area units in a digital twin based on amount of refrigeration area coverage provided by each respective refrigeration unit of a refrigeration system that controls temperature of the interconnected system environment.

The computer system collects ambient temperature and power consumption data corresponding to each respective server of a plurality of servers running workloads in each respective area unit of the plurality of area units comprising the interconnected system environment in the digital twin. The computer system generates the list of candidate area units of the plurality of area units comprising the interconnected system environment for placement of the server within the interconnected system environment based on the ambient temperature and power consumption data of each respective server of the plurality of servers running workloads in each respective area unit of the plurality of area units comprising the interconnected system environment in the digital twin. As a result, illustrative embodiments provide a technical effect of generating a list of candidate area units of a plurality of area units comprising an interconnected system environment for placement of a server within the interconnected system environment based on ambient temperature and power consumption data of each respective server of a plurality of servers running workloads in each respective area unit of the plurality of area units comprising the interconnected system environment in a digital twin.

The computer system retrieves historical network communication information corresponding to workloads running on a plurality of servers within the interconnected system environment. The computer system performs an analysis of the historical network communication information corresponding to the workloads running on the plurality of servers within the interconnected system environment. The computer system determines a probability of a set of server segments corresponding to certain server destination Internet Protocol (IP) addresses of the plurality of servers running the workloads within the interconnected system environment based on the analysis of the historical network communication information corresponding to the workloads running on the plurality of servers within the interconnected system environment. As a result, illustrative embodiments provide a technical effect of determining a probability of a set of server segments corresponding to certain server destination IP addresses of a plurality of servers running workloads within an interconnected system environment based on analysis of historical network communication information corresponding to the workloads running on the plurality of servers within the interconnected system environment.

The computer system, using a kernel density estimation algorithm, inferences the probability density value for server workload access associated with each respective server segment of a set of server segments corresponding to certain server destination IP addresses of a plurality of servers running the workloads within the interconnected system environment. The computer system identifies one or more intensive workload access destination server segments in the set of server segments corresponding to the certain server destination IP addresses of the plurality of servers running the workloads within the interconnected system environment having the probability density value for server workload access greater than the defined maximum probability density threshold value for server workload access. The computer system removes the one or more intensive workload access destination server segments having the probability density value for server workload access greater than the defined maximum probability density threshold value for server workload access from the set of server segments corresponding to the certain server destination IP addresses of the plurality of servers running the workloads within the interconnected system environment to form the set of destination server segments having the probability density value for server workload access less than the defined maximum probability density threshold value for server workload access. As a result, illustrative embodiments provide a technical effect of determining a set of destination server segments having a probability density value for server workload access less than a defined maximum probability density threshold value for server workload access by removing intensive workload access destination server segments having the probability density value for server workload access greater than the defined maximum probability density threshold value for server workload access from server segments corresponding to certain server destination IP addresses of a plurality of servers running workloads within an interconnected system environment.

A computer program product comprises one or more computer-readable storage media and program instructions stored on the one or more computer-readable storage media to perform operations. The computer program product detects an amount of network workload traffic between each candidate area unit in a list of candidate area units of a plurality of area units comprising an interconnected system environment in a digital twin and each of a set of destination server segments having a probability density value for server workload access less than a defined maximum probability density threshold value for server workload access. The computer program product removes those candidate area units from the list of candidate area units having a detected amount of network workload traffic to the set of destination server segments greater than a defined maximum network workload traffic threshold level. The computer program product generates a set of recommended candidate area units to place a server within the interconnected system environment based on removing those candidate area units from the list of candidate area units having the detected amount of network workload traffic to the set of destination server segments greater than the defined maximum network workload traffic threshold level. As a result, illustrative embodiments provide a technical effect of determining an appropriate area unit of a plurality of area units within an interconnected system environment to place a server to optimize temperature, power consumption, and workload response time based on amount of network workload.

The computer program product ranks the set of recommended candidate area units from least amount of detected network workload traffic to the set of destination server segments to greatest amount of detected network workload traffic to the set of destination server segments to form a ranked set of recommended candidate area units to place the server within the interconnected system environment. The computer program product outputs the ranked set of recommended candidate area units to place the server within the interconnected system environment to a client device of a user. As a result, illustrative embodiments provide a technical effect of ranking recommended candidate area units from least amount of detected network workload traffic to a set of destination server segments to greatest amount of detected network workload traffic to the set of destination server segments for recommending candidate area units to a user to place a server within an interconnected system environment.

The computer program product identifies an amount of refrigeration area coverage provided by each respective refrigeration unit of a refrigeration system that controls temperature of the interconnected system environment. The computer program product divides the interconnected system environment into the plurality of area units in the digital twin based on the amount of refrigeration area coverage provided by each respective refrigeration unit of the refrigeration system. As a result, illustrative embodiments provide a technical effect of dividing an interconnected system environment into a plurality of area units in a digital twin based on amount of refrigeration area coverage provided by each respective refrigeration unit of a refrigeration system that controls temperature of the interconnected system environment.

The computer program product collects ambient temperature and power consumption data corresponding to each respective server of a plurality of servers running workloads in each respective area unit of the plurality of area units comprising the interconnected system environment in the digital twin. The computer program product generates the list of candidate area units of the plurality of area units comprising the interconnected system environment for placement of the server within the interconnected system environment based on the ambient temperature and power consumption data of each respective server of the plurality of servers running workloads in each respective area unit of the plurality of area units comprising the interconnected system environment in the digital twin. As a result, illustrative embodiments provide a technical effect of generating a list of candidate area units of a plurality of area units comprising an interconnected system environment for placement of a server within the interconnected system environment based on ambient temperature and power consumption data of each respective server of a plurality of servers running workloads in each respective area unit of the plurality of area units comprising the interconnected system environment in a digital twin.

The computer program product retrieves historical network communication information corresponding to workloads running on a plurality of servers within the interconnected system environment. The computer program product performs an analysis of the historical network communication information corresponding to the workloads running on the plurality of servers within the interconnected system environment. The computer program product determines a probability of a set of server segments corresponding to certain server destination Internet Protocol (IP) addresses of the plurality of servers running the workloads within the interconnected system environment based on the analysis of the historical network communication information corresponding to the workloads running on the plurality of servers within the interconnected system environment. As a result, illustrative embodiments provide a technical effect of determining a probability of a set of server segments corresponding to certain server destination IP addresses of a plurality of servers running workloads within an interconnected system environment based on analysis of historical network communication information corresponding to the workloads running on the plurality of servers within the interconnected system environment.

The computer program product, using a kernel density estimation algorithm, inferences the probability density value for server workload access associated with each respective server segment of a set of server segments corresponding to certain server destination IP addresses of a plurality of servers running the workloads within the interconnected system environment. The computer program product identifies one or more intensive workload access destination server segments in the set of server segments corresponding to the certain server destination IP addresses of the plurality of servers running the workloads within the interconnected system environment having the probability density value for server workload access greater than the defined maximum probability density threshold value for server workload access. The computer program product removes the one or more intensive workload access destination server segments having the probability density value for server workload access greater than the defined maximum probability density threshold value for server workload access from the set of server segments corresponding to the certain server destination IP addresses of the plurality of servers running the workloads within the interconnected system environment to form the set of destination server segments having the probability density value for server workload access less than the defined maximum probability density threshold value for server workload access. As a result, illustrative embodiments provide a technical effect of determining a set of destination server segments having a probability density value for server workload access less than a defined maximum probability density threshold value for server workload access by removing intensive workload access destination server segments having the probability density value for server workload access greater than the defined maximum probability density threshold value for server workload access from server segments corresponding to certain server destination IP addresses of a plurality of servers running workloads within an interconnected system environment.

The computer program product receives a request to add the server to a plurality of servers running workloads in the interconnected system environment from a client device of a user. The computer program product, using a digital twin generation component, generates the digital twin of the interconnected system environment in response to receiving the request to add the server to the plurality of servers running workloads in the interconnected system environment. As a result, illustrative embodiments provide a technical effect of generating a digital twin of an interconnected system environment in response to receiving a request to add a server to a plurality of servers running workloads in an interconnected system environment.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A CPP embodiment is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc), or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

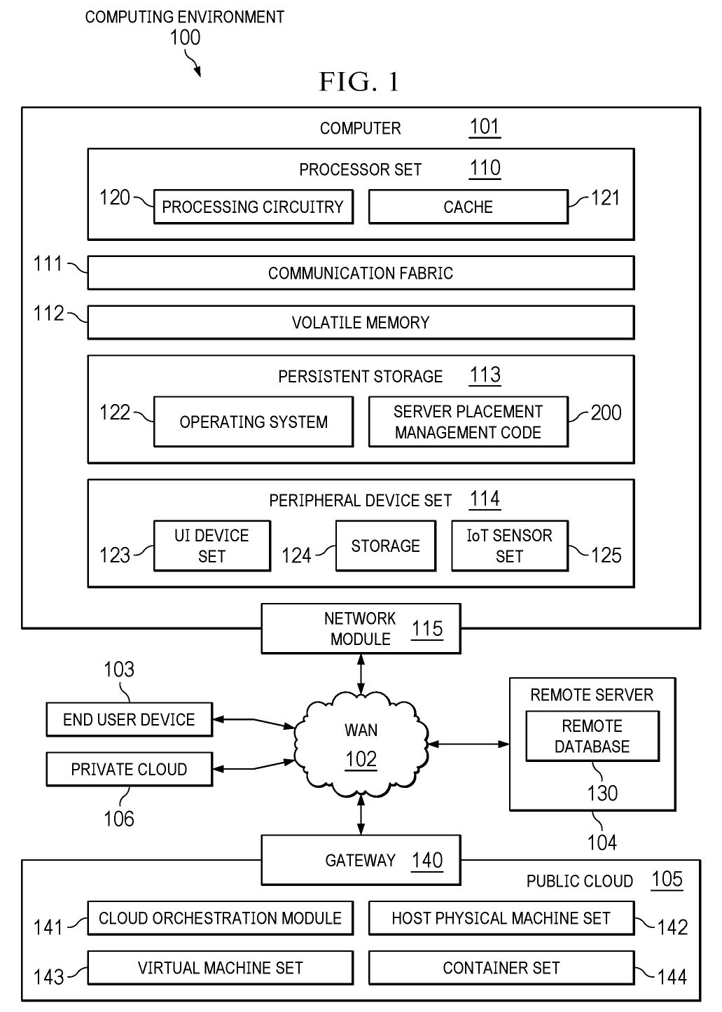

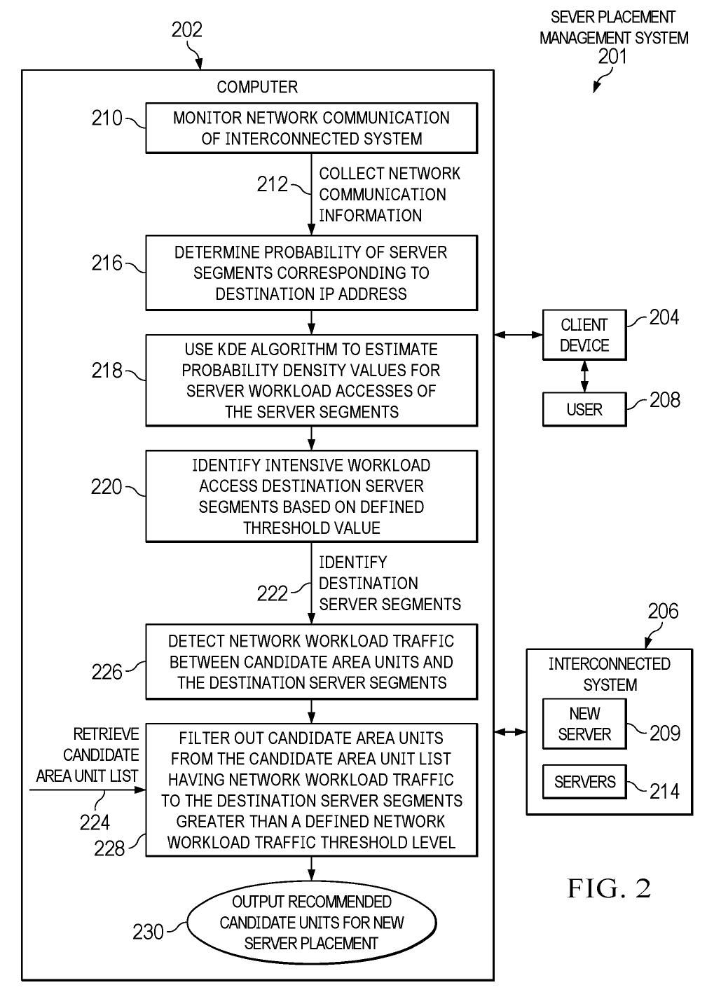

With reference now to the figures, and in particular, with reference to FIGS. 1 and 2, diagrams of data processing environments are provided in which illustrative embodiments may be implemented. It should be appreciated that FIGS. 1 and 2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods of illustrative embodiments, such as server placement management code 200.

For example, server placement management code 200 determines appropriate positioning of a new server within an interconnected system environment (e.g., a datacenter or the like) based on a digital twin that virtualizes the entire interconnected system environment. As used herein, an interconnected system environment is any physical location where a plurality of physical servers reside and are running workloads. Server placement management code 200 utilizes a digital twin generation component to generate a digital twin of the entire interconnected system environment. The digital twin is an accurate virtual representation of the interconnected system environment. Server placement management code 200 divides the interconnected system environment into a plurality of area units in the digital twin based on an amount of refrigeration area coverage provided by each respective refrigeration unit of the refrigeration system, which controls the temperature of the entire interconnected system environment. In addition, server placement management code 200 analyzes historical network communication information corresponding to each respective server in the interconnected system environment to recommend an appropriate area unit of the plurality of area units within the interconnected system environment to place the new server to optimize temperature, power consumption, and workload response time.

In addition to server placement management code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and server placement management code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a mainframe computer, quantum computer, desktop computer, laptop computer, tablet computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods of illustrative embodiments may be stored in server placement management code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input / output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source portable operating system interface-type operating systems that employ a kernel.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as smart glasses and smart watches), keyboard, mouse, printer, touchpad, and haptic devices.

Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers.

IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (e.g., a system administrator who utilizes the server placement services provided by computer 101), and may take any of the forms discussed above in connection with computer 101. EUD 103 typically receives helpful and useful data from the operations of computer 101. For example, in a hypothetical case where computer 101 is designed to provide a server placement recommendation to the end user, this recommendation would typically be communicated from network module 115 of computer 101 through WAN 102 to EUD 103. In this way, EUD 103 can display, or otherwise present, the server placement recommendation to the end user. In some embodiments, EUD 103 may be a client device, such as a thin client, heavy client, mainframe computer, desktop computer, laptop computer, tablet computer, smart phone, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a server placement recommendation based on historical network communication data corresponding to an interconnected system, then this historical network communication data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A, one of item B, and ten of item C, or four of item B and seven of item C, or other suitable combinations.

In existing interconnected systems, decreasing workload response time of servers poses a challenge. Approaches to this challenge focus on global temperature control of interconnected system environments and do not take into account the server workload response time when determining the positioning of servers within interconnected system environments.

Addressing this challenge requires a paradigm shift towards a more comprehensive consideration of the refrigeration system, anticipatory temperature adjustments, power consumption, and amount of network workload traffic corresponding to the servers within the interconnected system environment. In other words, a comprehensive understanding of this challenge is needed to develop a solution that can decrease temperature and decrease energy consumption of servers within the interconnected system environment. Illustrative embodiments take into account and address this challenge.

Illustrative embodiments receive a request to add a new server to a plurality of servers running workloads in an interconnected system environment from a client device of a user (e.g., system administrator or the like). In response to receiving the request to add the new server to the plurality of servers running workloads in the interconnected system environment, illustrative embodiments generate a digital twin of the interconnected system environment utilizing a digital twin generation component. Illustrative embodiments, using a plurality of sensors located throughout the interconnected system environment, identify an amount of refrigeration area coverage provided by each respective refrigeration unit of the refrigeration system that controls the temperature of the entire interconnected system environment. Illustrative embodiments divide the interconnected system environment into a plurality of area units in the digital twin based on the identified amount of refrigeration area coverage provided by each respective refrigeration unit of the refrigeration system.

In addition, illustrative embodiments, using the plurality of sensors, collect ambient temperature and power consumption data corresponding to each respective server of the plurality of servers running workloads in each respective area unit of the plurality of area units comprising the interconnected system environment in the digital twin. Illustrative embodiments generate a list of candidate area units of the plurality of area units comprising the interconnected system environment for placement of the new server within the interconnected system environment based on the ambient temperature and power consumption data of each respective server of the plurality of servers running workloads in each respective area unit of the plurality of area units comprising the interconnected system environment in the digital twin.

Further, illustrative embodiments retrieve and analyze historical network communication information corresponding to the workloads running on the plurality of servers within the interconnected system environment. Illustrative embodiments determine a probability of a set of server segments corresponding to certain server destination Internet Protocol (IP) addresses of the plurality of servers running the workloads within the interconnected system environment based on analyzing the historical network communication information corresponding to the workloads running on the plurality of servers within the interconnected system environment. Illustrative embodiments use a kernel density estimation algorithm to inference a probability density value for server workload access associated with each respective server segment of the set of server segments corresponding to the certain server destination IP addresses of the plurality of servers running the workloads within the interconnected system environment.

Illustrative embodiments identify one or more intensive workload access destination server segments in the set of server segments corresponding to the certain server destination IP addresses of the plurality of servers running the workloads within the interconnected system environment having the probability density value for server workload access greater than or equal to a defined maximum probability density threshold value for server workload access. The defined maximum probability density threshold value for server workload access may be, for example, 10%, 20%, 30%, or any other percentage value set by the user. Illustrative embodiments remove the one or more intensive workload access destination server segments having the probability density value for server workload access greater than or equal to the defined maximum probability density threshold value for server workload access from the set of server segments corresponding to the certain server destination IP addresses of the plurality of servers running the workloads within the interconnected system environment to form a set of destination server segments having the probability density value for server workload access less than the defined maximum probability density threshold value for server workload access.

Illustrative embodiments, using the plurality of sensors, detect an amount of network workload traffic between each candidate area unit in the list of candidate area units of the plurality of area units comprising the interconnected system environment in the digital twin and each of the set of destination server segments having the probability density value for server workload access less than the defined maximum probability density threshold value for server workload access. Illustrative embodiments remove those candidate area units from the list of candidate area units having a detected amount of network workload traffic to the set of destination server segments greater than or equal to a defined maximum network workload traffic threshold level to form a set of recommended candidate area units to place the new server within the interconnected system environment. Illustrative embodiments rank the set of recommended candidate area units from least amount of detected network workload traffic to the set of destination server segments to greatest amount of detected network workload traffic to the set of destination server segments. Illustrative embodiments output the ranked set of recommended candidate area units to place the new server within the interconnected system environment to the client device of the user.

Thus, the smart placement of servers within an interconnected system environment by illustrative embodiments streamlines operations, enhances resource allocation, and improves overall efficiency and effectiveness of deployed workloads running on the servers. Illustrative embodiments enable workload performance enhancement by automatically arranging server positioning within the interconnected system environment based on amount of network workload traffic, which will decrease workload response time, increase throughput, optimize energy consumption, and optimize resource utilization. Illustrative embodiments provide an ability to automatically recommend server placement based on historical data supporting scalability and adaptability to changing interconnected system environment needs, which enables illustrative embodiments to provide a flexible solution that can grow with the needs of interconnected system environments.

Thus, illustrative embodiments provide one or more technical solutions that overcome a technical problem with taking server workload response time into consideration when determining the appropriate positioning of new servers within interconnected system environments. As a result, these one or more technical solutions provide a technical effect and practical application in the field of interconnected systems.

With reference now to FIG. 2, a diagram illustrating an example of a server placement management system is depicted in accordance with an illustrative embodiment. Server placement management system 201 may be implemented in a computing environment, such as computing environment 100 in FIG. 1. Server placement management system 201 is a collection of hardware and software components for determining the appropriate positioning of new servers within interconnected system environments based on server workload response times.

In this example, server placement management system 201 includes computer 202, client device 204, and interconnected system 206. Computer 202 may be, for example, computer 101 in FIG. 1. Client device 204 may be, for example, EUD 103 in FIG. 1. Interconnected system 206 may be, for example, host physical machine set 142 in FIG. 1. However, it should be noted that server placement management system 201 is intended as an example only and not as a limitation on illustrative embodiments. For example, server placement management system 201 may include any number of computers, client devices, interconnected systems, and other devices and components not shown.

In this example, user 208 utilizes client device 204 to send a request to computer 202 to determine appropriate positioning of new server 209 within interconnected system 206. At 210, in response to receiving the request, computer 202 monitors network communication of interconnected system 206. At 212, based on the monitoring of the network communication, computer 202 collects network communication information corresponding to workloads running on servers 214 within interconnected system 206.

At 216, computer 202 determines probability of server segments corresponding to destination IP addresses based on the collected network communication information corresponding to the workloads running on servers 214. At 218, computer 202 uses a kernel density estimation (KDE) algorithm to estimate probability density values for server workload accesses of the server segments corresponding to the destination IP addresses.

At 220, computer 202 identifies intensive workload access destination server segments having probability density values for server workload access greater than a defined probability density threshold value for server workload access. At 222, computer 202 identifies destination server segments by filtering out the intensive workload access destination server segments.

At 224, computer 202 retrieves candidate area unit list corresponding to interconnected system 206. At 226, computer 202 detects network workload traffic between candidate area units contained in the candidate area unit list corresponding to interconnected system 206 and the identified destination server segments.

At 228, computer 202 filters out candidate area units from the candidate area unit list having network workload traffic to the destination server segments greater than a defined network workload traffic threshold level. At 230, in response to filtering out candidate area units from the candidate area unit list having network workload traffic to the destination server segments greater than the defined network workload traffic threshold level, computer 202 outputs recommended candidate units for placement of new server 209 within interconnected system 206 to client device 204 for user 208 review.

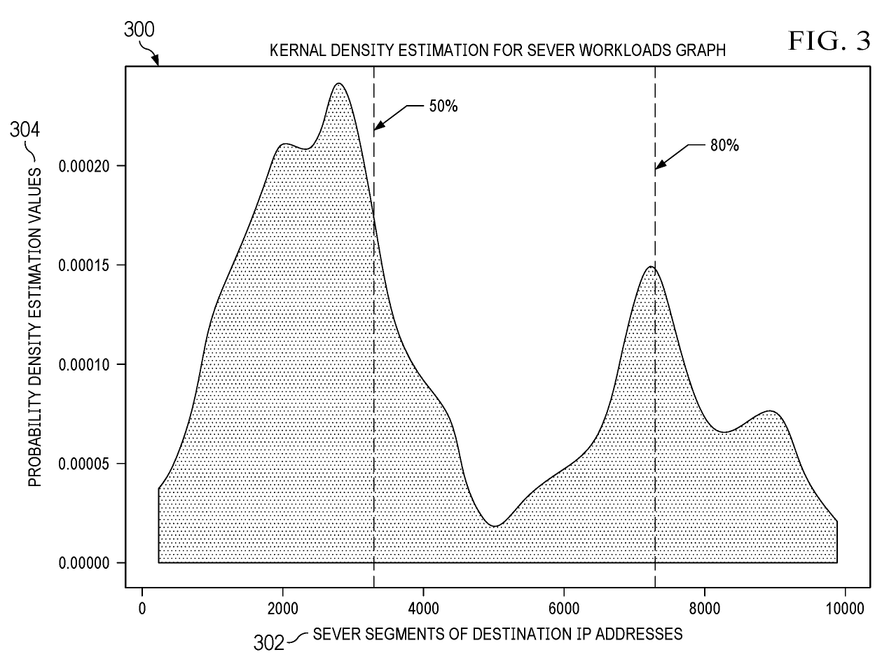

With reference now to FIG. 3, a diagram illustrating an example of a kernel density estimation for server workloads graph is depicted in accordance with an illustrative embodiment. Kernel density estimation for server workloads graph 300 may be implemented in a computer, such as, for example, computer 101 in FIG. 1 or computer 202 in FIG. 2. For example, kernel density estimation for server workloads graph 300 may be implemented by server placement management code 200 in FIG. 1.

The computer utilizes a KDE algorithm to inference the probability density values corresponding to destination server segments and generate kernel density estimation for server workloads graph 300. Kernel density estimation for server workloads graph 300 includes x-axis server segments of destination IP addresses 302 and y-axis probability density estimation values 304.

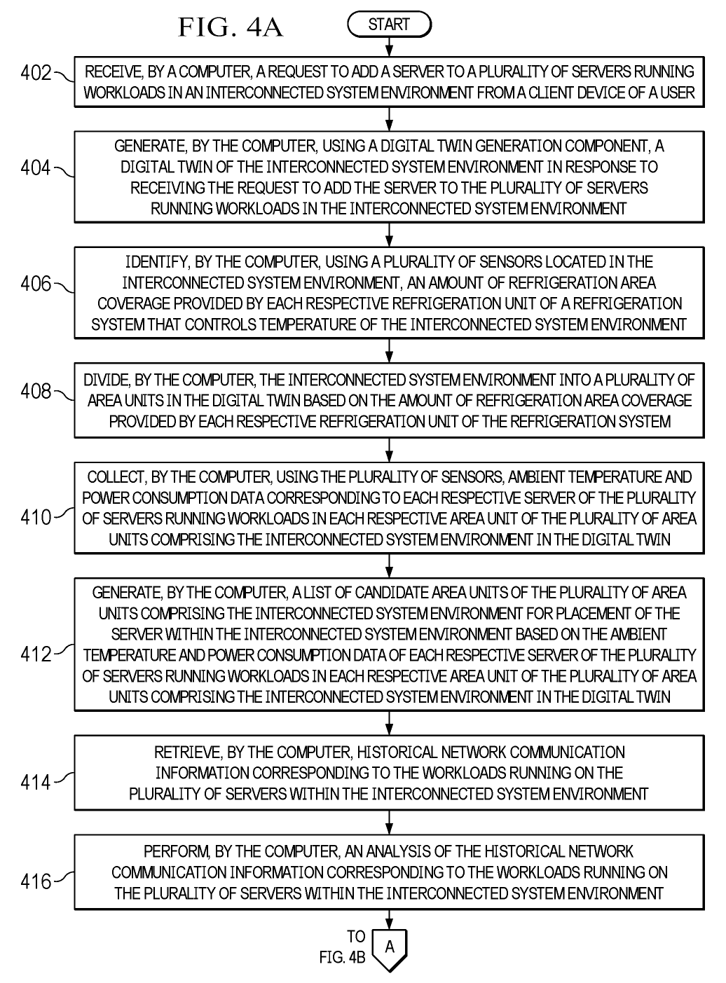

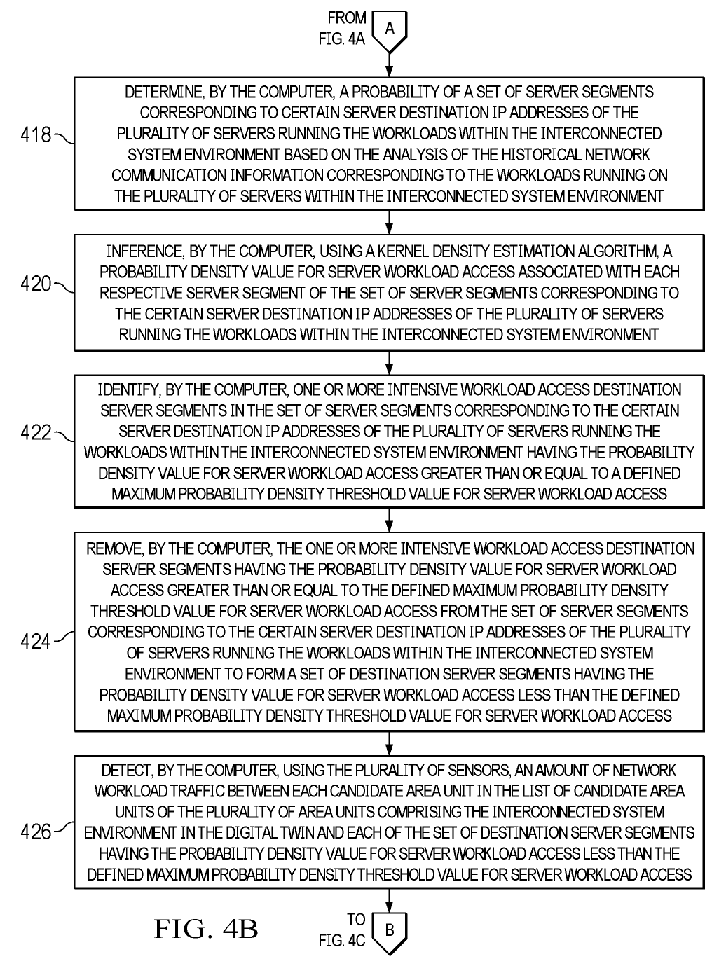

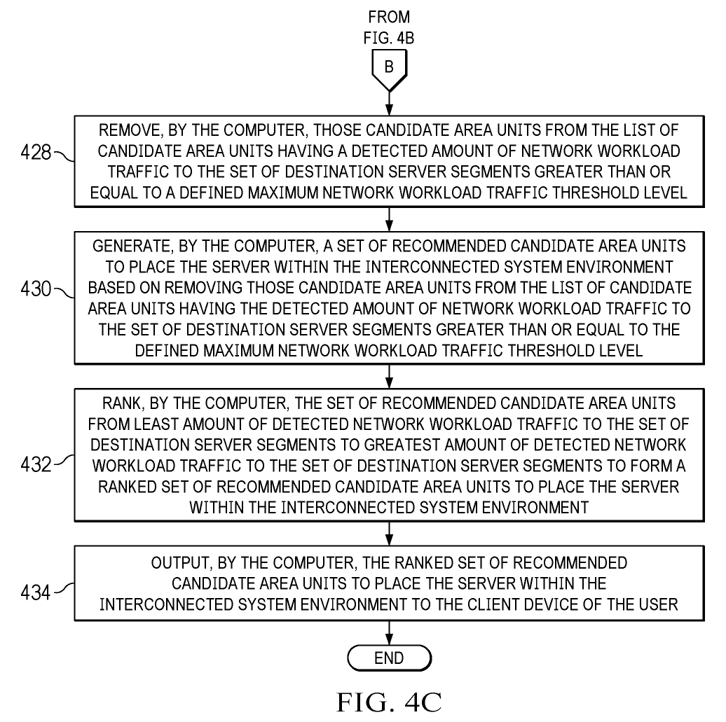

With reference now to FIGS. 4A-4C, a flowchart illustrating a process for positioning servers in interconnected systems using digital twins is shown in accordance with an illustrative embodiment. The process shown in FIGS. 4A-4C may be implemented in a computer, such as, for example, computer 101 in FIG. 1 or computer 202 in FIG. 2. For example, the process shown in FIGS. 4A-4C may be implemented by server placement management code 200 in FIG. 1.

The process begins when the computer receives a request to add a server to a plurality of servers running workloads in an interconnected system environment from a client device of a user (step 402). The computer, using a digital twin generation component, generates a digital twin of the interconnected system environment in response to receiving the request to add the server to the plurality of servers running workloads in the interconnected system environment (step 404).

In addition, the computer, using a plurality of sensors located in the interconnected system environment, identifies an amount of refrigeration area coverage provided by each respective refrigeration unit of a refrigeration system that controls temperature of the interconnected system environment (step 406). The computer divides the interconnected system environment into a plurality of area units in the digital twin based on the amount of refrigeration area coverage provided by each respective refrigeration unit of the refrigeration system (step 408).

Further, the computer, using the plurality of sensors, collects ambient temperature and power consumption data corresponding to each respective server of the plurality of servers running workloads in each respective area unit of the plurality of area units comprising the interconnected system environment in the digital twin (step 410). The computer generates a list of candidate area units of the plurality of area units comprising the interconnected system environment for placement of the server within the interconnected system environment based on the ambient temperature and power consumption data of each respective server of the plurality of servers running workloads in each respective area unit of the plurality of area units comprising the interconnected system environment in the digital twin (step 412).

Furthermore, the computer retrieves historical network communication information corresponding to the workloads running on the plurality of servers within the interconnected system environment (step 414). The computer performs an analysis of the historical network communication information corresponding to the workloads running on the plurality of servers within the interconnected system environment (step 416). The computer determines a probability of a set of server segments corresponding to certain server destination IP addresses of the plurality of servers running the workloads within the interconnected system environment based on the analysis of the historical network communication information corresponding to the workloads running on the plurality of servers within the interconnected system environment (step 418).

Moreover, the computer, using a kernel density estimation algorithm, inferences a probability density value for server workload access associated with each respective server segment of the set of server segments corresponding to the certain server destination IP addresses of the plurality of servers running the workloads within the interconnected system environment (step 420). The computer identifies one or more intensive workload access destination server segments in the set of server segments corresponding to the certain server destination IP addresses of the plurality of servers running the workloads within the interconnected system environment having the probability density value for server workload access greater than or equal to a defined maximum probability density threshold value for server workload access (step 422). The computer removes the one or more intensive workload access destination server segments having the probability density value for server workload access greater than or equal to the defined maximum probability density threshold value for server workload access from the set of server segments corresponding to the certain server destination IP addresses of the plurality of servers running the workloads within the interconnected system environment to form a set of destination server segments having the probability density value for server workload access less than the defined maximum probability density threshold value for server workload access (step 424).

The computer, using the plurality of sensors, detects an amount of network workload traffic between each candidate area unit in the list of candidate area units of the plurality of area units comprising the interconnected system environment in the digital twin and each of the set of destination server segments having the probability density value for server workload access less than the defined maximum probability density threshold value for server workload access (step 426). The computer removes those candidate area units from the list of candidate area units having a detected amount of network workload traffic to the set of destination server segments greater than or equal to a defined maximum network workload traffic threshold level (step 428).

The computer generates a set of recommended candidate area units to place the server within the interconnected system environment based on removing those candidate area units from the list of candidate area units having the detected amount of network workload traffic to the set of destination server segments greater than or equal to the defined maximum network workload traffic threshold level (step 430). The computer ranks the set of recommended candidate area units from least amount of detected network workload traffic to the set of destination server segments to greatest amount of detected network workload traffic to the set of destination server segments to form a ranked set of recommended candidate area units to place the server within the interconnected system environment (step 432). The computer outputs the ranked set of recommended candidate area units to place the server within the interconnected system environment to the client device of the user (step 434). Thereafter, the process terminates.

Thus, illustrative embodiments of the present disclosure provide a computer-implemented method, computer system, and computer program product for appropriately positioning servers within interconnected systems based on server workloads using digital twins. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
detecting an amount of network workload traffic between each candidate area unit in a list of candidate area units of a plurality of area units comprising an interconnected system environment in a digital twin and each of a set of destination server segments having a probability density value for server workload access less than a defined maximum probability density threshold value for server workload access;
removing those candidate area units from the list of candidate area units having a detected amount of network workload traffic to the set of destination server segments greater than a defined maximum network workload traffic threshold level; and
generating a set of recommended candidate area units to place a server within the interconnected system environment based on removing those candidate area units from the list of candidate area units having the detected amount of network workload traffic to the set of destination server segments greater than the defined maximum network workload traffic threshold level.

2. The computer-implemented method of claim 1, further comprising:
ranking the set of recommended candidate area units from least amount of detected network workload traffic to the set of destination server segments to greatest amount of detected network workload traffic to the set of destination server segments to form a ranked set of recommended candidate area units to place the server within the interconnected system environment; and
outputting the ranked set of recommended candidate area units to place the server within the interconnected system environment to a client device of a user.

3. The computer-implemented method of claim 1, further comprising:
identifying an amount of refrigeration area coverage provided by each respective refrigeration unit of a refrigeration system that controls temperature of the interconnected system environment; and
dividing the interconnected system environment into the plurality of area units in the digital twin based on the amount of refrigeration area coverage provided by each respective refrigeration unit of the refrigeration system.

4. The computer-implemented method of claim 1, further comprising:
collecting ambient temperature and power consumption data corresponding to each respective server of a plurality of servers running workloads in each respective area unit of the plurality of area units comprising the interconnected system environment in the digital twin; and
generating the list of candidate area units of the plurality of area units comprising the interconnected system environment for placement of the server within the interconnected system environment based on the ambient temperature and power consumption data of each respective server of the plurality of servers running workloads in each respective area unit of the plurality of area units comprising the interconnected system environment in the digital twin.

5. The computer-implemented method of claim 1, further comprising:
retrieving historical network communication information corresponding to workloads running on a plurality of servers within the interconnected system environment;
performing an analysis of the historical network communication information corresponding to the workloads running on the plurality of servers within the interconnected system environment; and
determining a probability of a set of server segments corresponding to certain server destination Internet Protocol (IP) addresses of the plurality of servers running the workloads within the interconnected system environment based on the analysis of the historical network communication information corresponding to the workloads running on the plurality of servers within the interconnected system environment.

6. The computer-implemented method of claim 1, further comprising:
inferencing, using a kernel density estimation algorithm, the probability density value for server workload access associated with each respective server segment of a set of server segments corresponding to certain server destination IP addresses of a plurality of servers running the workloads within the interconnected system environment;
identifying one or more intensive workload access destination server segments in the set of server segments corresponding to the certain server destination IP addresses of the plurality of servers running the workloads within the interconnected system environment having the probability density value for server workload access greater than the defined maximum probability density threshold value for server workload access; and
removing the one or more intensive workload access destination server segments having the probability density value for server workload access greater than the defined maximum probability density threshold value for server workload access from the set of server segments corresponding to the certain server destination IP addresses of the plurality of servers running the workloads within the interconnected system environment to form the set of destination server segments having the probability density value for server workload access less than the defined maximum probability density threshold value for server workload access.

7. The computer-implemented method of claim 1, further comprising:
receiving a request to add the server to a plurality of servers running workloads in the interconnected system environment from a client device of a user; and
generating, using a digital twin generation component, the digital twin of the interconnected system environment in response to receiving the request to add the server to the plurality of servers running workloads in the interconnected system environment.

8. A computer system comprising:
a processor set;
one or more computer-readable storage media; and
program instructions stored on the one or more computer-readable storage media to cause the processor set to perform operations comprising:
detecting an amount of network workload traffic between each candidate area unit in a list of candidate area units of a plurality of area units comprising an interconnected system environment in a digital twin and each of a set of destination server segments having a probability density value for server workload access less than a defined maximum probability density threshold value for server workload access;
removing those candidate area units from the list of candidate area units having a detected amount of network workload traffic to the set of destination server segments greater than a defined maximum network workload traffic threshold level; and
generating a set of recommended candidate area units to place a server within the interconnected system environment based on removing those candidate area units from the list of candidate area units having the detected amount of network workload traffic to the set of destination server segments greater than the defined maximum network workload traffic threshold level.

9. The computer system of claim 8, wherein the operations further comprise:
ranking the set of recommended candidate area units from least amount of detected network workload traffic to the set of destination server segments to greatest amount of detected network workload traffic to the set of destination server segments to form a ranked set of recommended candidate area units to place the server within the interconnected system environment; and
outputting the ranked set of recommended candidate area units to place the server within the interconnected system environment to a client device of a user.

10. The computer system of claim 8, wherein the operations further comprise:
identifying an amount of refrigeration area coverage provided by each respective refrigeration unit of a refrigeration system that controls temperature of the interconnected system environment; and
dividing the interconnected system environment into the plurality of area units in the digital twin based on the amount of refrigeration area coverage provided by each respective refrigeration unit of the refrigeration system.

11. The computer system of claim 8, wherein the operations further comprise:
collecting ambient temperature and power consumption data corresponding to each respective server of a plurality of servers running workloads in each respective area unit of the plurality of area units comprising the interconnected system environment in the digital twin; and
generating the list of candidate area units of the plurality of area units comprising the interconnected system environment for placement of the server within the interconnected system environment based on the ambient temperature and power consumption data of each respective server of the plurality of servers running workloads in each respective area unit of the plurality of area units comprising the interconnected system environment in the digital twin.

12. The computer system of claim 8, wherein the operations further comprise:
retrieving historical network communication information corresponding to workloads running on a plurality of servers within the interconnected system environment;
performing an analysis of the historical network communication information corresponding to the workloads running on the plurality of servers within the interconnected system environment; and
determining a probability of a set of server segments corresponding to certain server destination Internet Protocol (IP) addresses of the plurality of servers running the workloads within the interconnected system environment based on the analysis of the historical network communication information corresponding to the workloads running on the plurality of servers within the interconnected system environment.

13. The computer system of claim 8, wherein the operations further comprise:
inferencing, using a kernel density estimation algorithm, the probability density value for server workload access associated with each respective server segment of a set of server segments corresponding to certain server destination IP addresses of a plurality of servers running the workloads within the interconnected system environment;
identifying one or more intensive workload access destination server segments in the set of server segments corresponding to the certain server destination IP addresses of the plurality of servers running the workloads within the interconnected system environment having the probability density value for server workload access greater than the defined maximum probability density threshold value for server workload access; and
removing the one or more intensive workload access destination server segments having the probability density value for server workload access greater than the defined maximum probability density threshold value for server workload access from the set of server segments corresponding to the certain server destination IP addresses of the plurality of servers running the workloads within the interconnected system environment to form the set of destination server segments having the probability density value for server workload access less than the defined maximum probability density threshold value for server workload access.

14. A computer program product comprising:
one or more computer-readable storage media; and
program instructions stored on the one or more computer-readable storage media to perform operations comprising:
detecting an amount of network workload traffic between each candidate area unit in a list of candidate area units of a plurality of area units comprising an interconnected system environment in a digital twin and each of a set of destination server segments having a probability density value for server workload access less than a defined maximum probability density threshold value for server workload access;
removing those candidate area units from the list of candidate area units having a detected amount of network workload traffic to the set of destination server segments greater than a defined maximum network workload traffic threshold level; and
generating a set of recommended candidate area units to place a server within the interconnected system environment based on removing those candidate area units from the list of candidate area units having the detected amount of network workload traffic to the set of destination server segments greater than the defined maximum network workload traffic threshold level.

15. The computer program product of claim 14, wherein the operations further comprise:
ranking the set of recommended candidate area units from least amount of detected network workload traffic to the set of destination server segments to greatest amount of detected network workload traffic to the set of destination server segments to form a ranked set of recommended candidate area units to place the server within the interconnected system environment; and
outputting the ranked set of recommended candidate area units to place the server within the interconnected system environment to a client device of a user.

16. The computer program product of claim 14, wherein the operations further comprise:
identifying an amount of refrigeration area coverage provided by each respective refrigeration unit of a refrigeration system that controls temperature of the interconnected system environment; and
dividing the interconnected system environment into the plurality of area units in the digital twin based on the amount of refrigeration area coverage provided by each respective refrigeration unit of the refrigeration system.

17. The computer program product of claim 14, wherein the operations further comprise:
collecting ambient temperature and power consumption data corresponding to each respective server of a plurality of servers running workloads in each respective area unit of the plurality of area units comprising the interconnected system environment in the digital twin; and
generating the list of candidate area units of the plurality of area units comprising the interconnected system environment for placement of the server within the interconnected system environment based on the ambient temperature and power consumption data of each respective server of the plurality of servers running workloads in each respective area unit of the plurality of area units comprising the interconnected system environment in the digital twin.

18. The computer program product of claim 14, wherein the operations further comprise:
retrieving historical network communication information corresponding to workloads running on a plurality of servers within the interconnected system environment;
performing an analysis of the historical network communication information corresponding to the workloads running on the plurality of servers within the interconnected system environment; and
determining a probability of a set of server segments corresponding to certain server destination Internet Protocol (IP) addresses of the plurality of servers running the workloads within the interconnected system environment based on the analysis of the historical network communication information corresponding to the workloads running on the plurality of servers within the interconnected system environment.

19. The computer program product of claim 14, wherein the operations further comprise:
inferencing, using a kernel density estimation algorithm, the probability density value for server workload access associated with each respective server segment of a set of server segments corresponding to certain server destination IP addresses of a plurality of servers running the workloads within the interconnected system environment;
identifying one or more intensive workload access destination server segments in the set of server segments corresponding to the certain server destination IP addresses of the plurality of servers running the workloads within the interconnected system environment having the probability density value for server workload access greater than the defined maximum probability density threshold value for server workload access; and
removing the one or more intensive workload access destination server segments having the probability density value for server workload access greater than the defined maximum probability density threshold value for server workload access from the set of server segments corresponding to the certain server destination IP addresses of the plurality of servers running the workloads within the interconnected system environment to form the set of destination server segments having the probability density value for server workload access less than the defined maximum probability density threshold value for server workload access.

20. The computer program product of claim 14, wherein the operations further comprise:
receiving a request to add the server to a plurality of servers running workloads in the interconnected system environment from a client device of a user; and
generating, using a digital twin generation component, the digital twin of the interconnected system environment in response to receiving the request to add the server to the plurality of servers running workloads in the interconnected system environment.
